(19) United States
(12) Patent Application Publication
(10) Pub. No.: US 2002/0071012 A1
(43) Pub. Date: Jun. 13, 2002

(54) Liquid ink cartridge with improved wick compression

(75) Inventors: David P. Breemes SR., Palmyra, NY (US); Eric A. Merz, Palmyra, NY (US)

Correspondence Address: John E. Beck, Xerox Corporation, Xerox Square 20A, Rochester, NY, 14644, US

(73) Assignee: Xerox Corporation

(21) Appl. No.: 09/734,394

(22) Filed: Dec. 11, 2000

(51) Int. Cl. B41J 2/175

(52) U.S. Cl. 347/86

(57) ABSTRACT

A fluid cartridge, such as a cartridge for supplying ink for to an ink jet printhead, includes a wick chamber having outer walls, an ink outlet passing through one of the outer walls, and a porous wick member located in the wick chamber. Inner surfaces of the outer walls of the wick chamber are formed such that a portion of the wick proximate to the ink outlet is compressed by the inner surfaces to a larger degree than are portions of the wick distant from the ink outlet. The inner surfaces of the outer walls of the wick chamber may be formed such that they converge approaching the ink outlet.

### FIELD OF THE INVENTION

The present invention relates to ink cartridges used for supplying liquid ink to a printhead in an ink jet printing apparatus. More specifically, the present invention relates to structure and method for compressing the wick in the region of the ink outlet and thereby prohibiting premature de-priming of the ink outlet.

### BACKGROUND OF THE INVENTION

In existing ink jet printing devices, the printhead typically comprises one or more ink filled channels communicating with a relatively small supply chamber, or manifold, at one end, and having an opening at the opposite end, referred to as a nozzle. Droplets of ink are emitted or “jetted” out the nozzle onto a sheet of paper in a controlled fashion in order to generate a desired image on the paper. Various methods and devices for ink jet printing, such as thermal, piezo, and acoustic inkjet printers, are well understood in the art and are not described in detail herein.

In current practical embodiments of drop on demand ink jet printers, it has been found that the printers work most effectively when the pressure of the ink in the printhead nozzle is kept within a predetermined range of gauge pressures. Specifically, at those times during operation in which an individual nozzle or an entire printhead is not actively emitting a droplet of ink, it is important that a certain negative pressure, or “back pressure,” exist in each of the nozzles and, by extension, within the ink supply manifold of the printhead. The term “negative pressure”, as contained herein, means somewhat below atmospheric pressure, as is well understood in the art. Providing a negative pressure within the manifold and nozzles prohibits ink from dripping from the nozzles. The attributes of creating and maintaining such back pressure are described in further detail in U.S. Pat. No. 5,289,212, the contents of which are hereby incorporated herein as of reference.

The ink is typically supplied to the printhead from a replaceable ink cartridge that contains a supply of ink in an ink chamber or reservoir. When the ink in the ink cartridge has been depleted, the depleted cartridge is removed and a new full ink cartridge is installed in the printer. As with the printhead, it is desirable and known in the art to maintain a reduced pressure in the ink chamber and thereby prohibit ink from dripping from the cartridge's ink outlet during installation and removal of the cartridge from the printer, as well as during periods in which ink is not being jetted from the printhead.

FIGS. 1 and 2 are illustrative of an arrangement commonly used in the art for ink jet ink cartridges or ink tanks. In order to maintain the desired negative pressure within an ink cartridge 10, it is known to provide a wick 12 formed of porous material that is sealingly mounted in a wick chamber 14 formed in the ink cartridge 10. An ink outlet 16 communicates the wick chamber with the manifold in the print head (not shown) when the cartridge is installed in a printer (not shown). A quantity of ink 17 is stored in an ink chamber 18 formed in the ink cartridge. Ink must flow through the pores in the wick in order to travel from the ink chamber 18 to the ink outlet 16. The pores in the wick are suitably sized to behave as capillaries, such that a reduced pressure is required at the ink outlet in order to draw ink out of the cartridge.

It is also known to provide a vent opening 20 in such an ink cartridge 10, in order to allow air to enter the cartridge as ink is drawn therefrom. The wick 12 is sealingly mounted in the wick chamber 14 between the vent opening 20 and the ink chamber 18. The capillary action of the wick makes it necessary for there to be a reduced pressure within the cartridge compared to atmospheric pressure that is greater than the desired negative pressure before air will be drawn into the cartridge through the wick. Once enough air has entered the cartridge to rebalance the pressure within the cartridge to the desired negative pressure, then the wick prevents any more air from entering the cartridge 10. The capillary action of the wick 12 thus maintains the desired balance between negative pressure within the ink cartridge and the ambient atmosphere, and thereby substantially prohibits ink from dripping from the ink outlet 16. Such a wick containing ink cartridge is described in further detail in U.S. Pat. No. 5,997,121, the contents of which are hereby incorporated herein as of reference.

As ink is drawn from the ink outlet 16 and air enters the vent opening 20, the meniscus or interface between the ink saturated portion of the wick and the unsaturated portion of the wick illustrated by dashed line LI in FIG. 1 moves down as illustrated by dashed lines L2 and L3. Once the meniscus reaches a level approximately that of dashed line L3, air in the wick can enter the top of grooves 22 formed in a partition wall 24 that separates the wick chamber 14 from the ink chamber 18. The air can then easily travel from the unsaturated portion of the wick, through the grooves 22, through a passage 26 in the partition wall, and into the ink chamber 18. In this manner, when ink is drawn from the cartridge 10, air can enter the ink chamber and rebalance the pressure within the ink chamber to the desired reduced pressure relative the ambient environment.

In some instances, however, the meniscus moves down to a position approximately that of dashed line L4 in FIG. 1, in which the portion of the wick 12 adjacent the ink outlet 16 is unsaturated, while the portion of the wick 12 adjacent the grooves 22 remains saturated with ink. When such a condition exists, the ink outlet is “de-primed” and the jethead will draw air, rather than ink, out the ink outlet. The ink remaining in the ink chamber becomes trapped in the cartridge. The cartridge prematurely fails and the remaining ink is discarded.

### SUMMARY OF THE INVENTION

One form of the present invention provides a fluid cartridge for supplying fluid on demand, the cartridge comprising: a wick chamber having a plurality of outer walls having inner surfaces delimiting the wick chamber; an outlet opening through an outer wall of the wick chamber; a vent opening through an outer wall of the wick chamber; a fluid chamber having a plurality of outer walls; and a fluid conduit extending between the fluid chamber and the wick chamber; wherein at least two opposing inner surfaces of the wick chamber converge approaching the outlet opening, whereby when a porous wick is installed in the wick chamber a portion of the wick proximate to the outlet opening is more compressed by the inner surfaces than a portion of the wick distant from the outlet opening.

Another form of the present invention provides a cartridge for supplying ink on demand to an ink-jet printhead, the c e comprising: a housing having a top wall, a bottom wall, and a plurality of side walls extending between the top and bottom walls enclosing a substantially hollow interior chamber, a partition wall extending from the top wall toward the bottom wall and extending between two of the side walls dividing the interior chamber into a wick chamber and an ink chamber; a fluid conduit extending between the wick chamber and the ink chamber; a porous wick material in the wick chamber; a vent opening through one of the walls in the wick chamber portion of the housing; and an outlet opening through one of the walls in the wick chamber portion of the housing; wherein inner surfaces of at least two opposing walls of the wick chamber converge approaching the outlet opening, whereby a portion of the wick material adjacent to the outlet opening is compressed by the inner surfaces to a greater degree than a portion of the wick distant from the outlet opening.

The present invention also provides a method of forming an ink cartridge for supplying ink on demand to an ink-jet printhead, comprising the steps of: forming a housing having a bottom wall, four sidewalls substantially enclosing an interior chamber, and a dividing wall extending between opposing said sidewalls dividing said interior chamber into an ink chamber and a wick chamber, at least two opposing said sidewalls converging approaching said bottom wall; forming a top wall; inserting a porous wick member into said wick chamber, said wick member being formed such that a portion of said wick member proximate said bottom wall is compressed to a larger degree by said converging walls than a portion of said wick member distant from said bottom wall; providing an outlet opening into said wick chamber, said outlet opening being located in said bottom wall or in a lower portion of one of said sidewalls; and sealingly attaching said top wall to said sidewall enclosing said wick chamber and said ink chamber.

### BRIEF DESCRIPTION OF THE DRAWINGS

FIG. 1 is a side cross-sectional illustrative view of a prior art ink cartridge.

FIG. 2 is a front cross-sectional view of the prior art ink cartridge of FIG. 1 taken along line 2-2 in FIG. 1.

FIG. 3 is a side cross-sectional illustrative view of an improved ink cartridge incorporating a particular embodiment of the present invention.

FIG. 4 is a front cross-sectional view of the improved ink cartridge of FIG.3 taken along line 4-4 in FIG. 3.

### DESCRIPTION OF AN EMBODIMENT OF THE INVENTION

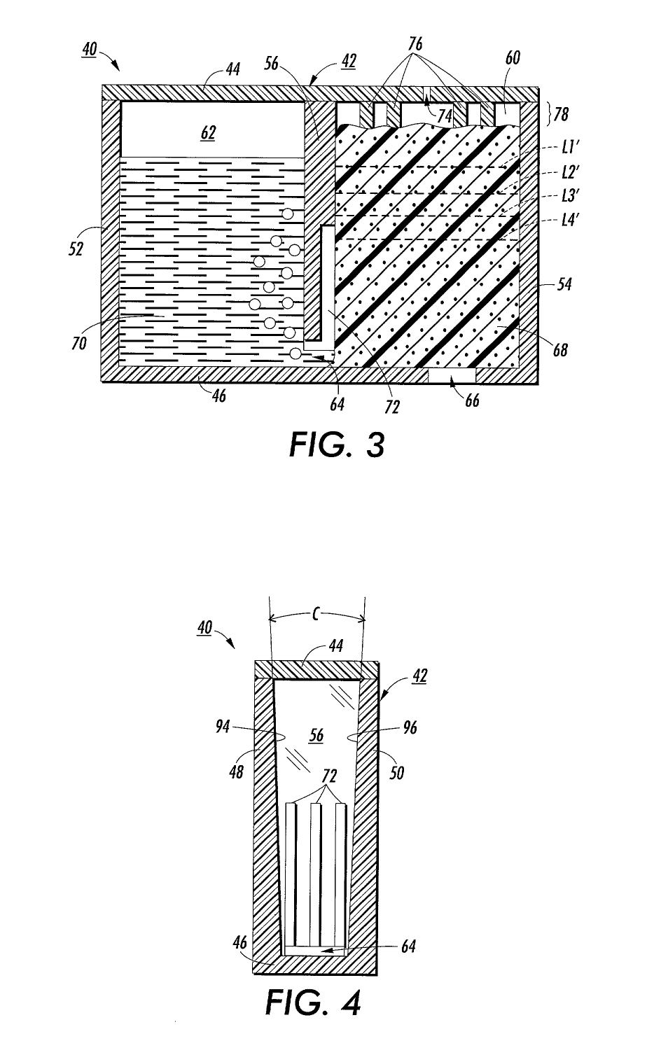

Referring now to FIGS. 3 and 4, an ink cartridge 40 according to an embodiment of the present invention includes a housing 42 formed of a plurality of walls 44, 46, 48, 50, 52, 54. FIG. 4 is a cross sectional view of FIG. 3 taken along line 4-4 in FIG. 3. In the particular cartridge illustrated, the walls of the housing include a top wall 44 and a substantially parallel and opposed bottom wall 46. Four sidewalls 48, 50, 52, 54 complete the housing. A divider or partition wall 56 extends from the top wall 44 toward the bottom wall 46, and also extends between two opposing side walls 48, 50, dividing the housing interior into a wick chamber 60 and an ink chamber 62.

A gap or through hole 64 is formed in the partition wall 56, adjacent the bottom wall 46 of the housing 42. The gap defines a fluid conduit or passage that provides fluid communication between the ink chamber 62 and the wick chamber 60. The fluid passage between the ink chamber and the wick chamber should be close to the bottom of the ink chamber. Those skilled in the art will recognize that the fluid passage may be formed in ways other than providing a gap in the partition wall. For example, the fluid passage may be formed by terminating the lower edge of the partition wall a short distance from the bottom wall, or a tube or other suitable structure extending between the ink chamber and the wick chamber may be alternatively employed.

An ink outlet opening 66 is formed through the bottom wall 46 of the housing 42 in the wick chamber 60. The outlet opening provides the point at which the cartridge interacts with the printhead (not shown), and through which ink is supplied from the cartridge to the ink jet printhead. The outlet opening 66 is shown in the bottom wall 46 of the wick chamber. However, the outlet opening may also be provided through one of the sidewalls 48, 50, or 54 of the housing at a location near the bottom of the wick chamber.

A seal (not shown) preferably covers the outlet opening 66 prior to the time at which the cartridge 40 is installed in the printing apparatus (not shown). For example, metallic tape, foil, or other material that the ink cannot penetrate is placed on and sealed to the outer surface of the wall having the outlet opening in order to seal the outlet opening. The seal is removed by the user before inserting the cartridge into the printer. However, in certain configurations, the seal may remain in place, and be punctured or otherwise penetrated by the printhead when the cartridge is installed in the printer.

An ink-retaining member, such as a wick 68, substantially fills the interior of the wick chamber 60. The wick material may be formed of any suitable porous material, such as a foam or fibrous material, and is well understood by those familiar with the art. For example, polyether foam material may be used as the wick 68. The wick is preferably somewhat compressed by the sidewalls 48, 50, 54 and 56 of the wick chamber in order to ensure a substantially fluid tight seal between the wick and the inner surface of the housing. When saturated with liquid (such as ink), the wick material facilitates the maintenance of the desired negative pressure for proper operation of the printhead. Therefore, the specific material may be different for different print apparatus configurations.

The ink chamber 62 is substantially free of ink retaining material. Liquid ink 70, stored in the ink chamber 62, is transferred from the ink chamber to the wick 68 through the fluid passage 64. The ink is released through the outlet opening 66 as necessary to supply the printhead with ink for printing.

Extending upward from the fluid passage 64 upward along the wick chamber side of the partition wall 56 are vertical grooves 72. These vertical grooves may be approximately ⅜ inch (1.0 cm) in length. The grooves assist in conducting ink from the ink chamber 62 into the wick material 68 in the wick chamber and in conducting air from wick material in the wick chamber into the ink chamber.

A vent opening 74 extends through one of the outer walls of the wick chamber. In the illustrated embodiment, the vent opening 74 extends through the top wall 44 of the wick chamber 60. The vent opening may, however, be located in one the housing sidewalls 48, 50, 54 near the top of the wick chamber. Projections, such as ribs 76, extend vertically down from the top wall 44 of the housing into the wick chamber 60. The ribs 44 maintain an air gap 78 between the top of the wick material 68 and the top wall 44 of the cartridge, so that the wick material does not come into contact with the vent opening 74. The vent opening 74 provides atmospheric or fluid communication between the wick chamber and the ambient environment.

The outer housing walls 44, 46, 48, 50, 52 forming the ink chamber 62 are integrally formed or sealed so that there is no fluid communication between the ink chamber and the ambient environment, except through the fluid passage 64 and the wick chamber 60. In the embodiment of the present invention illustrated in FIGS. 3 and 4, the housing bottom 46 and sidewalls 48, 50, 52, 54 of the ink cartridge 40 are integrally formed to form the housing 42. The housing top wall 44 is formed separately and sealingly attached to the top edges of the housing sidewalls, with the only opening in the top wall being the vent opening 74 located in the wick chamber 60. The two housing pieces may be molded of a plastic material, such as polypropylene, using known injection molding techniques. However, those skilled in the art will recognize that other materials and manufacturing techniques may be used to form the housing.

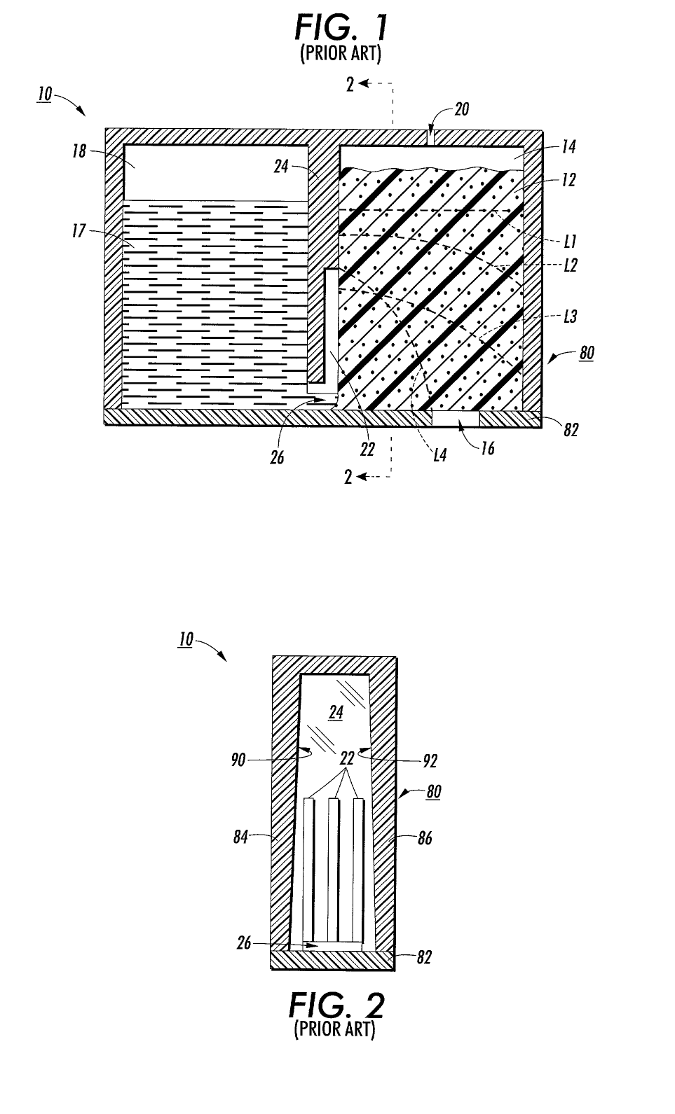

Upon viewing FIGS. 1 and 3 showing a common prior art ink cartridge configuration, it can be seen that the prior art cartridge 10 is formed of a five sided housing 80 that is open at the bottom and a separate bottom wall 82 that is sealingly attached the lower edges of the housing sidewalls. As opposed to the cartridge 40 according the present invention illustrated in FIGS. 3 and 4 that is formed of a five sided housing 42 that is open at the top and a separate top wall 44 that is sealingly attached the lower edges of the housing sidewalls.

In order to mold the cartridge housings 42 and 80 using known injection molding techniques, the parts must contain “draft”, i.e. a taper, so that the molded parts can be removed from the mold. The draft on the inside of the five-sided housings that is required for removal of the molding core is exaggerated for illustrative purposes in FIGS. 2 and 4. The necessary draft is created by forming the sidewalls 48, 50 and 84, 86 such that their opposing interior surfaces diverge moving from the closed end of the housing toward the open end. The divergence of the interior surfaces of the sidewall enables the core to be easily withdrawn from the housing.

The prior art cartridge of FIGS. 1 and 2 has a main housing 80 that is open at the bottom. As a result, the necessary draft causes the interior surfaces 90, 92 of opposing sidewalls 84, 86 to be spaced further apart at the bottom of the cartridge, than at the top. When the wick 12 is inserted into the wick cavity 14 in the prior art housing, the wick material is compressed near the top of the housing more than it is compressed near the bottom of the housing. As a result, the capillary forming pores in the wick 12 are more compressed and have a smaller diameter near the top of the housing 80, than near the bottom of the housing.

It is believed that the relatively smaller diameter capillaries have a stronger capillary affect than the relatively large diameter capillaries. This variation of the capillary action of the wick 12 is believed to cause the ink to be drawn more strongly into and retained more strongly by the more compressed areas of the wick, than by the less compressed areas of the wick. As previously mentioned, the wick in the prior art cartridge 10 is compressed more near the top of the cartridge than near the bottom. As a result, it is believed ink is more easily drained out of the wick 12 near the ink outlet opening 16, which is located at the bottom of the wick chamber 14, than it is drained out of the less compressed upper portion of the wick. This is believed to contribute to the migration of the meniscus L1 to a location approximating that of dashed line L4, in which the ink is completely drained from the portion of the wick adjacent to the outlet 16 and the outlet is de-primed.

According to the disclosed embodiment of the present invention illustrated in FIGS. 3 and 4, the main housing part 42 is formed open at the top, rather than the bottom. With this construction, the draft required for molding is provided by forming the cartridge such that opposing interior surfaces 94, 96 of the cartridge diverge moving from the bottom to the top of the cartridge 40. As a result, the wick 68 is more compressed near the bottom of the wick chamber 60, than it is near the top of the wick chamber. Although not shown in FIG. 3, it will be appreciated that the inner surfaces of walls 56 and 54 may converge in the wick chamber approaching the bottom wall 46, in addition to or in place of the convergence of walls 48 and 50.

Since the ink outlet 66 is in the bottom wall 46, where the wick 68 is relatively more compressed, it is believed that the downward migration of the meniscus L1′ will be more level, as illustrated by dashed lines L2′ through L4′ in FIG. 3, than in the prior art cartridges. In actuality, the meniscus will likely have a migration somewhere between that illustrated by dashed lines L1 to L3 in FIG. 1 and that illustrated by dashed lines L1′ to L4′ in FIG. 3. Thus, the present invention provides a simple and inexpensive method and structure for inhibiting premature depriming of the ink outlet 66.

FIG. 4 illustrates the inner surfaces 94, 96 of walls 48 and 50 as having an angle of convergence C from the top to the bottom of the wick chamber 56. With this construction, the compression of the wick (not shown in FIG. 4) is greatest immediately adjacent to the ink outlet 66 (not shown in FIG. 4) in the bottom wall 46. It will be appreciated that the angle of convergence/divergence of the walls may be equal to or greater than a minimum convergence required for the housing to easily separate from the molding core. Conventional molding operations commonly require a minimum interior angle of convergence of approximately 2 degrees to adequately facilitate release of the part from the molding core. The preferred minimum angle of convergence will vary depending upon the material being molded, the size of the part, as well as other factors, as is well understood by one of skill in the art.

The rate of convergence of the walls may vary. For example, inner surfaces 94 and 96 may converge more rapidly in a lower portion of the wick chamber than in an upper portion of the wick chamber, or may converge in a stepwise fashion. As such, the term “convergence” is intended to include a variable or stepwise convergence, as well as the smooth constant angle of convergence C illustrated in FIG. 4.

A fluid cartridge as described above can be filled through the vent opening 74 provided in the wick chamber. A fill nozzle (not shown) may be applied to the vent opening through the top wall 44 of the wick chamber 60, and ink directed from the fill nozzle into the wick chamber. The wick material 68 absorbs the ink, until the wick material is substantially saturated. Once the wick material is saturated, additional ink added to the wick chamber begins to flow through the fluid passage 64 into the ink chamber 62. The filling process is continued, until the ink chamber is substantially full of ink. Using a single vent opening for both filling the cartridge with ink and for venting, eliminates the need for a plug to fill a separate fill hole in the ink chamber.

Prior to filling with ink, the ink chamber 62 and wick chamber 60 are substantially evacuated of air or other gases, so that they contain a vacuum. However, as those familiar with the art will recognize, it is often impractical to obtain a perfect vacuum in a mass manufacturing operation. Therefore, it is almost inevitable that a small amount of air will remain in the ink chamber, forming a bubble as the ink chamber fills with ink, and preventing the ink from completing filling the ink chamber. The tape seal (not shown) is then applied over the top wall of the housing.

If the vent opening is opened (such as by removing the seal 50) when the internal pressure is higher than the external ambient pressure, then the air inside the chamber (particularly the air bubble in the ink chamber) expands, pushing ink 70 in the ink chamber 62 back into the wick chamber 60. If the wick material is fully saturated, some of the ink pushed into the wick chamber may rise into the gap 78 between the top of the wick material 68 and the top wall 44. The air in the gap escapes through the vent opening 74, thereby equalizing the pressure within the cartridge to the desired reduced pressure relative to ambient air. The “extra” ink is collected in the gap 78. The incidence of sudden ejection or squirting of ink from the vent opening when the seal (not shown) is removed is reduced by inclusion of a substantial air gap 78 between the wick and the wall containing the vent opening 74.

A specific embodiment of the present invention has been described. After reading the above description, those skilled in the art will identify various modifications that can be made to the embodiment described above without departing from the spirit of the invention. For example, other shapes of ink cartridges may incorporate the invention. Also, other shapes may be incorporated into the projections, or other structures may be used. In addition, the vent opening, the outlet opening, and other elements may be placed in different locations. Therefore, the above description is illustrative, and the scope of the claimed invention is not to be limited to the embodiment described above.

What is claimed is:

1. A fluid cartridge for supplying fluid on demand, the cartridge comprising:
a plurality of outer walls having inner surfaces defining a chamber, with an outlet opening through one of said outer walls and at least two opposing said inner surfaces converging approaching the outlet opening; and
a porous wick installed in the chamber, with a portion of the wick proximate the outlet opening being compressed to a greater degree than a portion of the wick distant from the outlet opening.

2. The cartridge of claim 1, further comprising a vent opening through one of said outer walls.

3. The cartridge of claim 1, further comprising a plurality of outer walls having inner surfaces defining a fluid chamber; and
a fluid conduit extending between the fluid chamber and the wick chamber.

4. The cartridge of claim 1, wherein the convergence of said at least two inner surfaces is approximately equal to or greater than a draft required for molding the cartridge.

5. The cartridge according to claim 1, wherein the convergence of said at least two inner surfaces is equal to or greater than two degrees.

6. The cartridge of claim 1, wherein the cartridge is substantially formed of two parts:
a housing comprising a bottom and all side walls of the wick chamber and the fluid chamber outer walls; and
a cap comprising a top wall of the wick chamber and the fluid chamber outer walls.

7. The cartridge of claim 6, wherein the outlet opening is through the bottom wall;
and inner surfaces of at least two opposing said sidewalls of the wick chamber converge approaching the bottom wall.

8. The cartridge according to claim 7, wherein the vent opening is through the top wall.

9. The cartridge of claim 6, wherein the convergence of the side walls is approximately equal to or greater than a draft required for molding the housing part.

10. The cartridge according to claim 6, wherein the convergence of the side walls is equal to or greater than two degrees.

11. The cartridge of claim 1, additionally comprising:
structure adjacent the vent opening to prevent contact between the wick material and the vent opening.

12. The cartridge of claim 2, wherein the vent opening is above the outlet opening.

13. The cartridge of claim 3, wherein the vent opening is above the fluid conduit.

14. The cartridge of claim 1, wherein one of the outer walls of the wick chamber is a top wall and the vent opening is through the top wall.

15. The cartridge of claim 1, wherein said fluid is ink for an inkjet printer and said cartridge is an ink tank for installation in an inkjet printer to supply ink to an inkjet printhead.

16. A cartridge for supplying ink on demand to an inkjet printhead, the cartridge comprising:
a plurality of outer walls having inner surfaces defining a chamber, with an outlet opening through one of said outer walls and at least two opposing said inner surfaces converging approaching the outlet; and
a porous wick in the chamber, whereby a portion of the wick adjacent to the outlet opening is compressed by the converging inner surfaces to a greater degree than a portion of the wick distant from the outlet opening.

17. A cartridge according to claim 16, further comprising a partition wall extending between two opposing said side outer walls dividing the chamber into a wick chamber and an ink chamber.

18. A cartridge according to claim 17, further comprising a vent opening through one of the outer walls of the wick chamber.

19. A cartridge according to claim 17, further comprising a fluid conduit extending between the wick chamber and the ink chamber.

20. A cartridge according to claim 16, wherein the outlet opening is located in a lower portion of the chamber.

21. A cartridge according to claim 20, further comprising a vent opening located in an upper portion of the chamber.

22. A cartridge according to claim 17, wherein the cartridge outer walls comprise:
a bottom wall, a top wall and a plurality of side walls, with the bottom wall, side walls and partition wall being integrally formed to provide an open topped housing, and the top wall being separately formed and sealingly attached to the top of the housing.

23. The cartridge of claim 22, wherein the fluid comprises a gap in the partition wall adjacent the bottom wall of the housing.

24. A cartridge according to claim 22, wherein the outlet opening is located in the bottom wall and at least two opposing said sidewalls are formed with said converging inner surfaces.

25. A cartridge according to claim 22, wherein the housing is molded and the convergence of said at least two sidewall inner surfaces is equal to or greater than a convergence required to facilitate release of the part from the mold.

26. A cartridge according to claim 22, wherein said at least two side wall inner surfaces converge at an angle of at least about 2 degrees.

27. A cartridge according to claim 22, wherein said at least two side wall inner surfaces converge at an angle that is greater than 2 degrees.

28. A cartridge according to claim 16, wherein the cartridge is molded and the convergence of said at least two sidewall inner surfaces is equal to or greater than a convergence required to facilitate release of the part from the mold.

29. A cartridge according to claim 16, wherein said at least two inner surfaces converge at an angle that is greater than 2 degrees.

30. A method of forming an ink cartridge for supplying ink on demand to an ink-jet printhead, comprising the steps of:
forming a housing having a plurality of outer walls having inner surfaces defining a chamber, with an outlet opening through one of said outer walls and at least two opposing said inner surfaces converging approaching the outlet opening;
inserting a porous wick member into said chamber, such that a portion of said wick member proximate said outlet opening is compressed to a larger degree than a portion of said wick member distant from said outlet opening.

31. The method of claim 31, wherein the step of forming a housing comprises:
forming a housing having side walls integrally formed with a bottom wall defining an open topped chamber, with said outlet opening in said bottom wall and at least two opposing said sidewalls forming said at least two converging inner surfaces approaching the outlet opening;
separately forming a top wall;
sealingly attaching said top wall to a top of said sidewalls enclosing said chamber.

32. A method according to claim 31, wherein the housing is molded and the angle of convergence of said two opposing inner surfaces is selected to be equal to or greater than a convergence required for effective release of the housing from the mold.

33. A cartridge according to claim 32, wherein said at least two opposing inner surfaces converge at an angle that is greater than 2 degrees.
